(19) United States
(12) Patent Application Publication
(10) Pub. No.: US 2015/0138422 A1
(43) Pub. Date: May 21, 2015

(54) OPTICAL MEMBER, IMAGE PICKUP APPARATUS, AND METHOD FOR MANUFACTURING OPTICAL MEMBER

(71) Applicant: CANON KABUSHIKI KAISHA, Tokyo (JP)

(72) Inventors: Akira Sugiyama, Yokohama-shi (JP); Zuyi Zhang, Yokohama-shi (JP); Yoshinori Kotani, Yokohama-shi (JP); Akiko Takei, Fujisawa-shi (JP); Norishige Kakegawa, Tokyo (JP); Kenji Takashima, Tokyo (JP); Naoyuki Koketsu, Tokyo (JP); Tomoaki Masubuchi, Yokosuka-shi (JP)

(21) Appl. No.: 14/403,976

(22) PCT Filed: Apr. 24, 2013
(86) PCT No.: PCT/JP2013/002780

§ 371 Date: Nov. 25, 2014

(30) Foreign Application Priority Data
May 30, 2012 (JP) 2012-123567
Mar. 18, 2013 (JP) 2013-055539

(51) Int. Cl. G02B 1/118; C03C 17/02

(52) U.S. Cl. CPC G02B 1/118; C03C 17/02; C03C 2217/425
USPC 348/335; 428/138; 65/31

(57) ABSTRACT

To provide an optical member in which crystallization is suppressed and which has a porous glass layer on a base material.

An optical member has a base material 1 and a porous glass layer 2 which is formed on the base material 1 and has a three-dimensional through pore, in which the existence ratio of crystals of 0.2 micrometer or more in the porous glass layer 2 is 1.0% or lower.

### TECHNICAL FIELD

The present invention relates to an optical member having a porous glass layer on a base material, an image pickup apparatus having the optical member, and a method for manufacturing the optical member.

### BACKGROUND ART

In recent years, porous glass has been expected to be industrially utilized as an adsorbent, a microcarrier support, a separation film, an optical material, and the like, for example. In particular, the porous glass has been widely utilized as an optical member due to the fact that the refractive index is low.

As a method for relatively easily manufacturing the porous glass, a method utilizing a phase separation phenomenon is mentioned. As the base material of the porous glass obtained utilizing the phase separation phenomenon, borosilicate glass containing silicon oxide, boron oxide, alkali metal oxide, or the like as the raw materials is generally used. The porous glass is manufactured by causing the phase separation phenomenon by heat treatment including holding a molded borosilicate glass at a fixed temperature (hereinafter referred to as phase separation treatment), and then eluting a non-silicon-oxide-rich phase which is a soluble component by etching using an acidic solution (hereinafter referred to as etching treatment). The skeleton constituting the porous glass thus manufactured mainly contains silicon oxide. The skeleton diameter, the pore diameter, and the porosity of the porous glass affect the reflectance and the refractive index of light.

PTL 1 and PTL 2 disclose a method for forming a porous glass layer on a base material. Specifically, the porous glass layer is formed on the base material by applying a glass paste onto a base material, firing the same to form a base glass layer, and then performing phase separation heat treatment and etching treatment.

### CITATION LIST

### Patent Literature

PTL 1: Japanese Patent Laid-Open No. 01-083583
PTL 2: Japanese Patent Laid-Open No. 01-192755

### SUMMARY OF INVENTION

### Technical Problem

When applying the manufacturing method disclosed in PTL 1 or PTL 2 to a method for manufacturing an optical member, the following problems arise.

More specifically, when used as an optical member, film uniformity at a high level is demanded, and thus it is desirable to reduce cavities in a glass film. However, the glass film is formed by fusing a glass paste, cavities are likely to be formed (FIG. 9).

Thus, there is an idea of giving high energy during fusing to uniformly form film. However, according to this method, since the given energy contributes also to crystallization of silicon oxide, crystals are likely to be generated in the glass film (FIG. 10). When crystals exist in the porous glass film, a difference in the refractive index between a crystal portion and other portions arises, so that the scattering degree and the like become high.

The present invention provides an optical member which hardly causing scattering and has a porous glass layer on a base material and a method for manufacturing the same.

### Solution to Problem

An optical member of the invention has a base material and a porous glass layer which is formed on the base material and has a three-dimensional through pore, in which the existence ratio of crystals of 0.2 micrometer or more in the porous glass layer is 1.0% or lower.

A method for manufacturing an optical member of the invention is a method for manufacturing an optical member having a base material and a porous glass layer formed on the base material, and the method includes a process for forming a glass powder layer containing a plurality of glass powders on the base material, a process for fusing the plurality of glass powders of the glass powder layer to form a base glass layer, a process for phase separating the base glass layer to form a phase-separated glass layer, and a process for etching the phase-separated glass layer to form a porous glass layer, in which the process for forming the base glass layer includes a process for heating the glass powder layer at a temperature elevation rate of 50 degree/min or higher to a temperature equal to or higher than the crystallization temperature of the glass powder.

### Advantageous Effects of Invention

The invention can provide an optical member in which scattering is suppressed and which has a porous glass layer on a base material and a method for manufacturing the same.

### BRIEF DESCRIPTION OF DRAWINGS

FIG. 1 is a view illustrating an example of an optical member of the invention.

FIG. 2 is a view showing the relationship between the existence ratio of crystals of 0.2 micrometer or more and haze in a porous glass layer.

FIG. 3 is a view for describing the porosity.

FIG. 4A is a view for describing the average pore diameter and the average skeleton diameter.

FIG. 4B is a view for describing the average pore diameter and the average skeleton diameter.

FIG. 5 is a schematic view illustrating an example of an image pickup device having the optical member of the invention.

FIG. 6A is a schematic view illustrating an example of a method for manufacturing the optical member of the invention.

FIG. 6B is a schematic view illustrating an example of the method for manufacturing the optical member of the invention.

FIG. 6C is a schematic view illustrating an example of the method for manufacturing the optical member of the invention.

FIG. 6D is a schematic view illustrating an example of the method for manufacturing the optical member of the invention.

FIG. 7 is a view showing the relationship between the temperature elevation rate during fusing and the haze of the optical member.

FIG. 8 is a view showing the dependence of the reflectance on the wavelength in Examples 1 to 3 and Comparative Examples 1 and 2.

FIG. 9 is a view illustrating an example of cavities in a porous glass layer.

FIG. 10 is a view illustrating an example of crystals in the porous glass layer.

FIG. 11 is a view illustrating an example of a porous structure derived from spinodal type phase separation.

FIG. 12 is a view illustrating an example of a porous structure derived from binodal type phase separation.

### DESCRIPTION OF EMBODIMENT

Hereinafter, the invention is described in detail with reference to an embodiment of the invention. To portions which are not particularly illustrated or disclosed in this specification, well-known or known techniques of the concerned technical field are applied.

The “phase separation” which forms the porous structure in the invention is described taking a case where a borosilicate glass containing silicon oxide, boron oxide, and oxide containing alkali metal for a glass body as an example. The “phase separation” means separating the phases in glass into a phase containing the oxide containing alkali metal and the boron oxide in a higher proportion than the proportion thereof before phase separation (non-silicon-oxide-rich phase) and a phase containing the oxide containing alkali metal and the boron oxide phase in a lower proportion than the proportion thereof before phase separation (silicon-oxide-rich phase). Then, the phase-separated glass is etched to remove the non-silicon-oxide-rich phase, thereby forming a porous structure in the glass body.

The phase separation includes spinodal type phase separation and binodal type phase separation. As a porous glass structure utilizing the phase separation, there are a porous structure derived from the spinodal type phase separation and a porous structure derived from the binodal type phase separation. The porous structure derived from the spinodal type phase separation and the porous structure derived from the binodal type phase separation are judged and distinguished from the shape observation results obtained by a scanning electron microscope (SEM). Specifically, the cross section of the porous glass layer is observed at a magnification of 150,000 times at an accelerating voltage of 5.0 kV using a scanning electron microscope (FE-SEM S-4800, manufactured by Hitachi).

The pores of the porous glass obtained by the spinodal type phase separation are through pores communicating from the surface to the inner portion. More specifically, the porous structure derived from the spinodal type phase separation is a structure having a shape of an “ant nest”, in which pores three dimensionally communicate with each other and the skeleton formed by silicon oxide corresponds to a “nest” and the through pore corresponds to a “nesting hole”. More specifically, when the pores of the porous structure observed in a field of a magnification of 150,000 times at an accelerating voltage of 5.0 kV using a scanning electron microscope are through pores as illustrated in FIG. 11, the porous structure is the porous structure derived from the spinodal type phase separation.

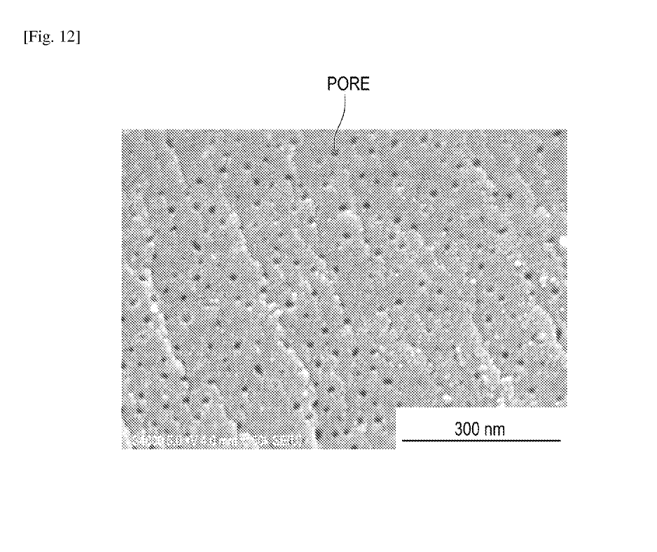

On the other hand, the porous glass obtained by the binodal type phase separation is a structure in which independent pores which are pores surrounded by a closed surface close to a spherical shape discontinuously exist in the skeleton formed by silicon oxide. More specifically, when the pores of the porous structure observed in a field of a magnification of 150,000 times at an accelerating voltage of 5.0 kV using a scanning electron microscope are independent pores as illustrated in FIG. 12, the porous structure is the porous structure derived from the binodal type phase separation.

The cross-sectional shape of the pores of the porous structure derived from the binodal type phase separation is an approximately circular shape. On the other hand, the cross-sectional shape of the pores of the porous structure derived from the spinodal type phase separation is different from the circular shape and has a branch shape. Therefore, in the porous structure derived from the spinodal type phase separation, the cross-sectional shape of the skeleton also has a branch shape. These cross-sectional shapes are shapes obtained when observed in a field of a magnification of 150,000 times at an accelerating voltage of 5.0 kV using a scanning electron microscope. The porous structure according to each phase separation type can be controlled by controlling the composition of the glass body and the temperature during phase separation.

The invention utilizes the spinodal type phase separation. The porous structure derived from the spinodal type phase separation has a continuous through pore having a three-dimensional net-like continuous through pore communicating from the surface to the inner portion, in which the porosity can be arbitrarily controlled by changing the heat treatment conditions. The porous structure has a skeleton which is continuous while three dimensionally complicatedly bending. Thus, even when the porosity is increased, high strength can be achieved. Thus, since excellent surface strength can be achieved while maintaining high porosity, the invention can provide an optical member which has excellent antireflection performance and also has strength with which the surface is difficult to be damaged even when touching the surface.

### Optical Member

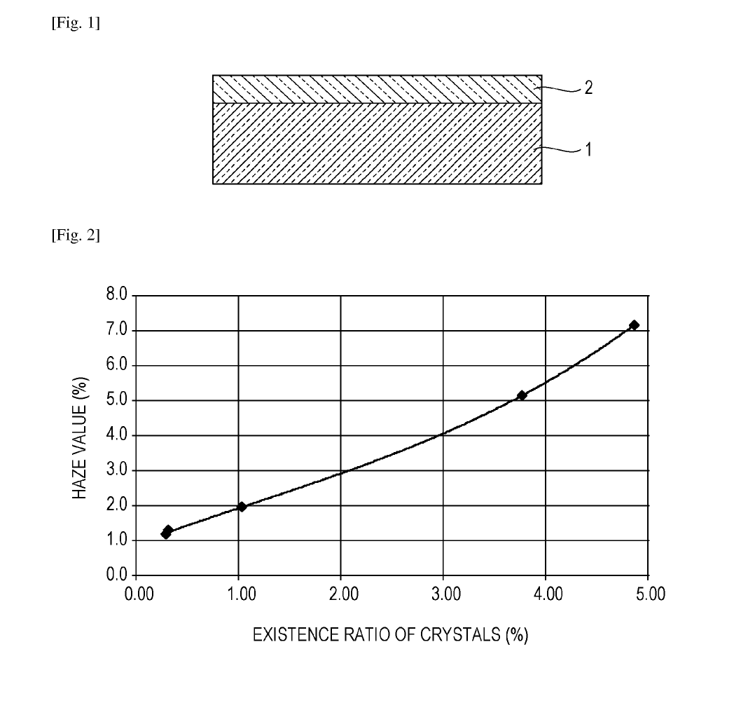

The optical member of the invention has a configuration of having a porous glass layer 2 having a porous structure derived from the spinodal type phase separation in which pores three dimensionally communicate with each other on a base material 1 as illustrated in FIG. 1. Since the porous glass layer 2 is a film whose refractive index is lower than that of the base material 1, the reflection on the interface (surface of the porous glass layer 2) of the porous glass layer 2 and air is suppressed. Thus, the porous glass layer is expected to be utilized as an optical member.

In the optical member of the invention, the existence ratio of crystals of 0.2 micrometer or more in the porous glass layer is 1.0% or lower. With this configuration, since there are few crystals of 0.2 micrometer or more which considerably contribute to the haze, the haze value is 2.0% or lower as shown in FIG. 2, so that the porous glass layer can be utilized for most optical members. When used as an antireflection coating film of an image pickup apparatus and the like, the haze value is more suitably 0.3% or lower.

The haze value can be measured using a haze meter (NDH2000, manufactured by Nippon Denshoku, Inc.).

In the invention, the crystal of 0.2 micrometer or more refers to a crystal in which the longest length among the lengths of the straight lines connecting two points on the line of the outline of the crystal is 0.2 micrometer or more and the form of the crystal is not limited at all.

For the measurement of the existence ratio of the crystals of 0.2 micrometer or more in the porous glass layer 2, the following measurement method can be used.

Specifically, a field of 2.4 mm in length*3.2 mm in width of the porous glass layer 2 is observed under an optical microscope at a magnification of 100 times. The observed field is divided into 100 parts, each part is saved as an image having resolution which allows observation of crystals of 0.2 micrometer or more. Then, optical microscope images are graphed based on the frequency of image density using an image analyzing software. Subsequently, a crystal portion containing crystals of 0.2 micrometer or more (dark portion) and another portion (bright portion) are monochromatically binarized in each image. The ratio of the area of the black portion of all the images of the entire area of all the images (total of the white portion area and the black portion area) is determined to be used as the existence ratio (%) of crystals. The existence ratio of the crystals is indicated by two significant digits.

The crystals can be judged by the observation using a transmission electron microscope. The form of the crystal is confirmed by the unit described above, and then it is enlarged to a magnification which allows the observation of the form using an optical microscope, whereby it may be judged whether or not it is a crystal.

The crystal existence ratio of 0.35% or lower is suitable because haze is further suppressed.

The porosity of the porous glass layer 2 is suitably 20% or more and 70% or lower and more suitably 20% or more and 60% or lower. When the porosity is lower than 20%, advantages of the porous structure cannot be sufficiently utilized. When the porosity is higher than 70%, the surface strength tends to decrease, and thus the porosity is not suitable. The fact that the porosity of the porous glass layer 2 is 20% or more and 70% or lower is equivalent to the fact that the refractive index is 1.10 or more and 1.40 or lower.

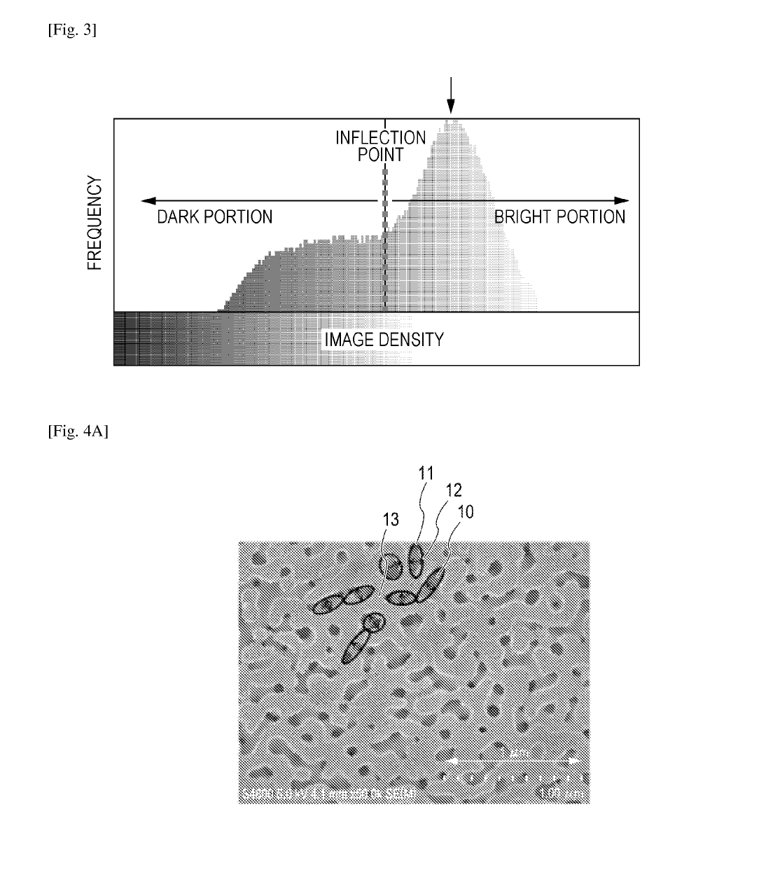

The following measurement method can be used for the measurement of the porosity. Treatment for binarizing an electron micrograph at a skeleton portion and a pore portion is performed. Specifically, the surface of the porous glass is observed at a magnification of 100,000 times (depending on the case, 50,000 times) at which the contrast of the skeleton is easily observed at an accelerating voltage of 5.0 kV using a scanning electron microscope (FE-SEM S-4800, manufactured by Hitachi). The observed image is saved as an image, and then the SEM image is graphed at the frequency of each image density using an image analyzing software. FIG. 3 is a view illustrating the frequency of each image density of the porous structure of the spinodal type porous structure. The peak portion indicated by the downward arrow of the image density of FIG. 12 represents the skeleton portion located at the front. The inflection point near the peak position is used as the threshold value, and then the bright portion (skeleton portion) and the dark portion (pore portion) are monochromatically binarized. The average value of all the images for the ratio of the black portion area to the entire area (total of the white portion area and the black portion area) is determined to be used as the porosity.

The thickness of the porous glass layer 2 is not particularly limited and is suitably 0.2 micrometer or more and 20.0 micrometer or lower and more suitably 0.2 micrometer or more and 10.0 micrometer or lower. When the thickness is smaller than 0.2 micrometer, the effects of high porosity (low refractive index) are not obtained. When the thickness is larger than 20.0 micrometer, the influence of scattering becomes high, so that the porous glass layer becomes difficult to be used as an optical member.

Specifically, with respect to the thickness of the porous glass layer 2, an SEM image (electron micrograph) is captured at an accelerating voltage of 5.0 kV using a scanning electron microscope (FE-SEM S-4800, manufactured by Hitachi). The thickness of the porous glass layer 2 portion on the base material 1 is measured at 30 or more portions from the captured image, and the average value is used.

The porous glass layer 2 may have a configuration such that one or two or more porous glass layers may be laminated on the porous glass layer 2. As the entire porous glass layer 2, a configuration such that the porosity becomes higher from the base material 1 side to the surface of the porous glass layer is suitable because the effects of low reflectance are obtained.

In the optical member of the invention, a non-porous film whose refractive index is lower than that of the porous glass layer 2 may be provided on the surface of the porous glass layer 2.

Between the base material 1 and the porous glass layer 2, a gradient layer in which the refractive index has a gradient may be provided. As an example, as the gradient layer, one which is constituted by a porous film and whose porosity has a gradient in the film thickness direction can be used. Or, a configuration such that that a plurality of porous films whose porosities are different from each other are laminated may be acceptable. In any case, in order to use the same as an optical member, it is necessary to have a configuration such that the porosity becomes higher from the base material 1 side to the porous glass layer 2.

The pore diameter of the porous glass layer 2 is suitably 1 nm or more and 100 nm or lower, more suitably 5 nm or more and 50 nm or lower, and still more suitably 5 nm or more and 20 nm or lower. When the pore diameter is smaller than 1 nm, the charac-teristics of the structure of the porous body cannot be sufficiently utilized. When the pore diameter is larger than 100 nm, the surface strength tends to decrease. Thus the pore diameters are not suitable. When the pore diameter is 20 nm or lower, the scattering of light is noticeably suppressed, and thus the pore diameter is suitable. The pore diameter is suitably smaller than the thickness of the porous glass layer 2.

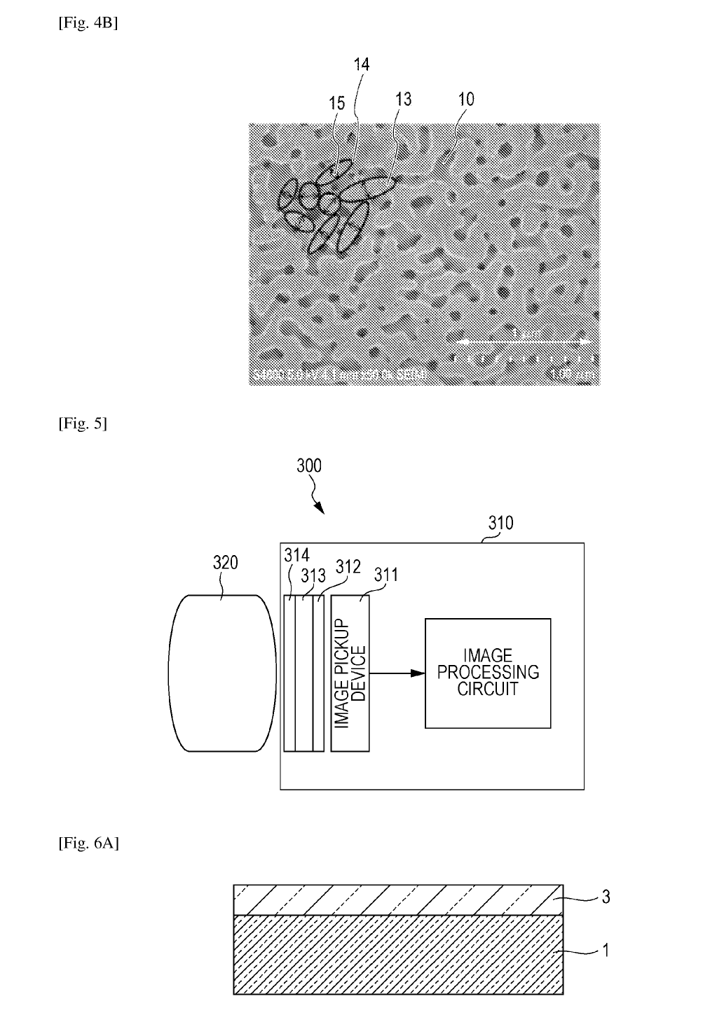

The pore diameter in the invention is defined as the average value of the minor axis in each of a plurality of ellipses by which the pores in a region of 5 micrometer*5 micrometer among arbitrary cross sections of the porous body are approximated. Specifically, as illustrated in FIG. 4A, for example, the value is obtained by approximating pores 10 by a plurality of ellipses 11 with reference to the electron micrograph of the porous body surface, and then calculating the average value of a minor axis 12 in each ellipse. At least 30 or more points are measured, and the average value thereof is determined.

The average skeleton diameter of the porous glass layer 2 is suitably 1 nm or more and 500 nm or lower, more suitably 5 nm or more and 50 nm or lower, and still more suitably 5 nm or more and 20 nm or lower. When the skeleton diameter is larger than 100 nm, the scattering of light is noticeable, so that the transmittance sharply decreases. When the skeleton diameter is smaller than 1 nm, the strength of the porous glass layer 2 tends to become small. When the skeleton diameter is larger than 500 nm, the denseness of the film is impaired, so that the strength of the porous glass layer 2 becomes small. When the skeleton diameter is 20 nm or lower, the scattering of light is suppressed, and thus the skeleton diameter is suitable.

The skeleton diameter in the invention is defined as the average value of the minor axis in each of a plurality of ellipses by which the skeletons in a region of 5 micrometers*5 micrometers among arbitrary cross sections of the porous body are approximated. Specifically, as illustrated in FIG. 4B, for example, the value is obtained by approximating skeletons 13 by a plurality of ellipses 14 with reference to the electron micrograph of the porous body surface, and then calculating the average value of a minor axis 15 in each ellipse. At least 30 or more points are measured, and the average value is calculated.

Attention is paid to the fact that since the scattering of light is complexly affected by the film thickness and the like of the optical member, the scattering of light is not uniquely determined only by the pore diameter and the skeleton diameter.

The pore diameter and the skeleton diameter of the porous glass layer 2 can be controlled by the materials serving as the raw materials, the heat treatment conditions in the spinodal type phase separation, and the like.

As the base material 1, a base material containing an arbitrary material can be used according to the purpose. As the material of the base material 1, quartz glass and crystal are suitable, for example, from the viewpoint of transparency, heat resistance, and strength. The base material 1 may have a configuration such that layers containing different materials are laminated.

The base material 1 is suitably transparent. The transmittance of the base material 1 is suitably 50% or more and more suitably 60% or more in a visible light region (wavelength region of 450 nm or more and 650 nm or lower). When the transmittance is lower than 50%, a problem sometimes arises when used as an optical member.

The haze value of the base material 1 is suitably 0.10% or lower. The base material 1 may be a material of a low pass filter or a lens.

Mentioned as the optical member of the invention are specifically optical members, such as various displays of a television, a computer, and the like, a polarizer for use in a liquid crystal display, a finder lens for camera, a prism, a fly eye lens, and a toric lens, various lenses, such as an imaging optical system employing the same, an observation optical system, such as binoculars, a projection optical system for use in a liquid crystal projector and the like, and a scanning optical system for use in a laser beam printer, and the like.

The optical member of the invention may be mounted also on an image pickup apparatus, such as a digital camera and a digital video camera. FIG. 5 is a cross sectional schematic view illustrating a camera (image pickup apparatus) employing the optical member of the invention, specifically an image pickup apparatus for forming an image of a target image from a lens on an image pickup device through an optical filter. An image pickup apparatus 300 has a body 310 and a removable lens 320. An image pickup device, such as a digital single-lens reflex camera, can obtain various imaging screens of various field angles by exchanging an imaging lens for use in imaging to a lens having a different focal length. The body 310 has an image pickup device 311, an infrared cut filter 312, a low pass filter 313, and an optical member 314 of the invention. The optical member 314 has a base material 1 and a porous glass layer 2 as illustrated in FIG. 1.

The optical member 314 and the low pass filter 313 may be integrally formed or may be separated elements. A configuration such that the optical member 314 serves also as a low pass filter may be acceptable. More specifically, the base material 1 of the optical member 314 may be a low pass filter.

The image pickup device 311 is housed in a package (not illustrated). The package houses the image pickup device 311 in a sealing state with a cover glass (not illustrated). The space between the optical filter, such as the low pass filter 313 and the infrared cut filter 312, and the cover glass is sealed with a sealing member, such as double-stick tape. An example in which both the low pass filter 313 and the infrared cut filter 312 are provided is described as an optical filter but an optical filter having either one may be acceptable.

Since a portion near the surface of the optical member 314 of the invention has a porous structure, the portion has excellent dustproof performance, such as suppression of adhesion of dust. Thus, the optical member 314 is disposed in such a manner as to be located at the side opposite to the image pickup device 311 of the optical filter. The optical member is disposed in such a manner that the porous glass layer 2 is further from the image pickup device 311 relative to the base material 1. In other words, it is suitable that the optical member 314 is disposed in such a manner that the base material 1 and the porous glass layer 2 are located in the stated order from the image pickup device 311 side. The optical member 314 and the image pickup device 311 are mutually disposed in such a manner that an image which transmits the optical member 314 can be captured by the image pickup device 311.

In the image pickup apparatus 300 of the invention, a foreign substance removal apparatus (not illustrated) for removing a foreign substance by applying vibration or the like may be provided. The foreign substance removal apparatus is configured in such a manner as to have a vibration member, a piezoelectric element, and the like.

The foreign substance removal apparatus may be disposed at any position insofar as the foreign substance removal apparatus is located between the image pickup device 311 and the optical member 314. For example, the foreign substance removal apparatus may be provided in such a manner that the vibration member is in contact with the optical member 314, the vibration member is in contact with the low pass filter 313, or the vibration member is in contact with the infrared cut filter 312. When the foreign substance removal apparatus is provided in such a manner that the vibration member is in contact with the optical member 314, foreign substances, such as dust and dirt, are hard to adhere to the optical member 314. Thus, the foreign substances can be more efficiently removed therefrom.

The vibration member of the foreign substance removal apparatus may be integrally formed with the optical member 314 or the optical filter, such as the low pass filter 313 or the infrared cut filter 312. The vibration member may be constituted by the optical member 314 and may have functions of the low pass filter 313, the infrared cut filter 312, and the like.

### Method for Manufacturing Optical Member

A method for manufacturing an optical member of the invention includes forming a glass powder layer containing a plurality of glass powders on a base material, fusing the glass powders of the glass powder layer to form a base glass layer, and then phase separating and etching the base glass layer to form a porous glass layer on the base material.

Since the film of the porous glass layer of the optical member is required to have uniformity, it is desirable to reduce cavities larger than the pores in the porous glass layer as much as possible. The number of such cavities is suitably smaller in that the cavities cause haze (scattering). However, in the base glass layer in which glass powders are fused as in the invention, the cavities are likely to be formed.

As a method for reducing the cavities, there is an idea of applying high energy during fusing. The temperature region of the fusing temperature and the temperature region of the crystallization temperature of a phase separable glass powder are close to each other. In order to promote the fusing of glass powders, it is required to perform heat treatment at a temperature equal to or higher than the crystallization temperature of the glass powder.

According to this method, however, when fusing the glass powders, crystals are sometimes generated in the base glass film which is a resultant substance. The crystals remain in the porous glass layer. When the crystals exist in the porous glass layer, a difference in the refractive index between the crystal portion and another portion (amorphous portion) is large, which poses a problem such that the scattering degree becomes high.

As a reason why the crystallization occurs, although the specific mechanism thereof is not clarified, the reason is imagined as follows.

More specifically, in the phase separable glass powder, components other than the silicon oxide of the surface volatilize into the air, so that the composition of the glass surface is different from the internal composition. When comparing with a usual glass block in terms of the same volume, the surface area of an aggregation of glass powders becomes large. Thus, it is considered that the glass powder layer has a large number of silicon oxide rich portions, so that crystals originating from the silicon oxide are likely to be generated.

The present inventors have found that, by controlling the temperature elevation rate in the fusing process of the glass powder layer, changes in the composition of the glass powder are suppressed and the existence ratio of the crystals of 0.2 micrometer or more in the porous glass of the obtained optical member is suppressed. The temperature elevation rate is described later.

As a result of reducing the cavities and the crystallization, the porous glass layer in which the scattering originating from the cavities and the scattering originating from the skeleton are reduced can be formed, so that the porous glass layer can be suitably used as an optical member.

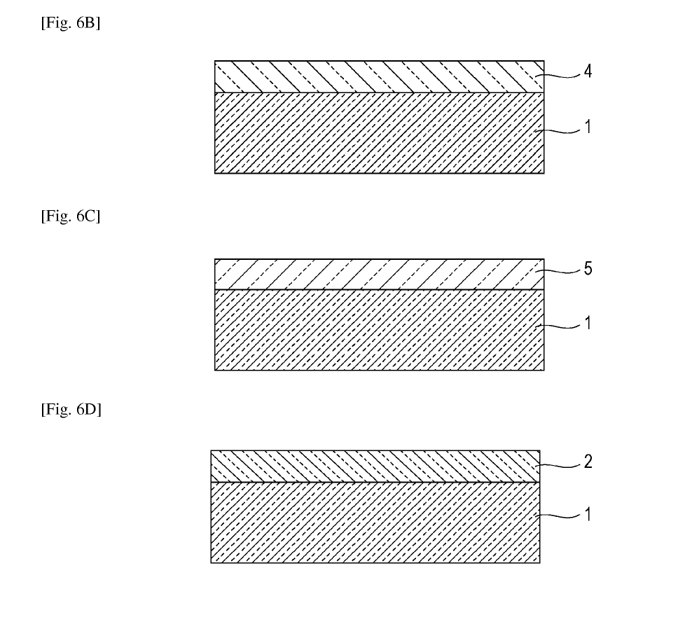

A detailed manufacturing method is described below with reference to FIG. 6.

### Process for Forming Glass Powder Layer

As illustrated in FIG. 6A, first, a glass powder layer 3 containing a plurality of glass powders is formed on the base material 1. The composition of the glass powder may be set as appropriate according to an optical member.

As a method for forming the glass powder layer 3, all the manufacturing methods capable of forming a film, such as a printing method, a spin coating method, and a dip coating method, are mentioned, for example. Among the above, as a method to be suitably used for forming the glass powder layer 3 of an arbitrary glass composition, a printing method using screen printing is mentioned.

Hereinafter, a description is given with reference to a method using a general screen printing method as an example. Since a glass powder is formed into a paste, and is printed using a screen printer in the screen printing method, the preparation of the paste is indispensable.

A base glass formed into the glass powder can be manufactured using known methods. For example, the base glass can be manufactured by heating and melting raw materials containing the supply source of each component, and molding the resultant substance into a desired shape as required.

Any glass powder layer 3 may be used insofar as it is a phase separable glass powder.

The heating temperature for heating and melting may be determined as appropriate in accordance with the raw material composition and the like and is usually in the range of 1350 degree or higher and 1450 degree or lower and particularly suitably 1380 degree or higher and 1430 degree or lower.

In order to use the same as a paste, the base glass is pulverized to obtain glass powder. A pulverization method is not required to be particularly limited, and known pulverization methods can be used. Mentioned as an example of the pulverization method is a crushing method in a liquid phase typified by a bead mill or a crushing method in a vapor phase typified by a jet mill. The paste contains a thermoplastic resin, a plasticizer, a solvent, and the like with the above-described glass powder.

It is desirable that the proportion of the glass powder contained in the paste is in the range of 30.0% by weight or more and 90.0% by weight or lower and suitably in the range of 35.0% by weight or more and 70.0% by weight or lower.

The thermoplastic resin contained in the paste is a component which increases the film strength after drying and imparts flexibility. Usable as the thermoplastic resin are polybutyl metacrylate, polyvinyl butyral, polymethyl metacrylate, polyethyl metcrylate, ethyl cellulose, and the like. The thermoplastic resin can be used alone or as a mixture of two or more kinds thereof.

Mentioned as the plasticizer contained in the paste are butyl benzyl phthalate, dioctyl phthalate, diisooctyl phthalate, dicapryl phthalate, dibutyl phthalate, and the like. These plasticizers can be used alone or as a mixture of two or more kinds thereof.

Mentioned as the solvent contained in the paste are terpineol, diethylene glycol monobutyl ether acetate, 2,2,4-trimethyl-1,3-pentadiol monoisobutyrate, and the like. The solvents can be used alone or as a mixture of two or more kinds thereof.

The paste may be produced by kneading the above-described materials at a given ratio. By applying the paste thus produced onto the base material 1 using a screen printing method, the glass powder is formed. Specifically, by drying and removing the solvent component of the paste after applying the paste, the glass powder layer 3 is formed.

The temperature and the time for drying and removing the solvent can be changed as appropriate in accordance with the solvent to be used. It is suitable to dry the same at a temperature lower than the decomposition temperature of the thermoplastic resin. When the drying temperature is higher than the decomposition temperature of the thermoplastic resin, glass particles are not fixed. When formed into the glass powder layer 3, the generation of defects and irregularities are likely to be noticeable.

The use of the base material 1 achieves an effect of suppressing deformation of the glass layer caused by the heat treatment in the phase separation process and an effect of easily adjusting the film thickness of the porous glass layer 2.

The softening temperature of the base material 1 is suitably equal to or higher than the heating temperature (phase separation temperature) in a phase separation process described later for and is more suitably equal to or higher than a temperature obtained by adding 100 degree to the phase separation temperature. When the base material is a crystal, the melting temperature is the softening temperature. When the softening temperature is lower than the phase separation temperature, the base material 1 deforms in the phase separation process, and thus the temperature is not suitable.

It is suitable that the base material 1 has resistance to etching of a phase separable glass layer 5 described later. For example, quartz glass and crystal can be used for the base material 1.

### Process for Forming Base Glass Layer

Next, as illustrated in FIG. 6B, the glass powder layer 3 is heated to fuse glass powders, and then a phase separable base glass layer 4 is formed on the base material 1. The phase separability refers to that the glass layer has a characteristic of causing the phase separation phenomenon described above at a certain heating temperature.

In the invention, the glass powder layer 3 is heated to a temperature equal to or higher than the crystallization temperature of the glass powder at a temperature elevation rate of 50 degree/min or higher, and then heat treated to thereby form the base glass layer 4.

The glass powder can be fused by heat treating the same at a temperature equal to or higher than the glass transition temperature Tg (degree). According to our ex-amination, by heat treating a phase separable glass powder in a temperature region equal to or higher than the crystallization temperature Tc (degree), cavities in a film decrease, so that a more uniform film is formed.

On the other hand, by performing fusing in a temperature region equal to or higher than the crystallization temperature, crystals are likely to be observed in the glass film.

As described above, the present inventors have found that, by heating the glass powder layer 3 at a temperature elevation rate of 50 degree/min or higher, the generation of crystals of 0.2 micrometer or more can be suppressed. By heating the same to a temperature equal to or higher than the crystallization temperature of the glass powder at the temperature elevation rate, cavities can be reduced.

By setting the temperature elevation rate to 50 degree/min or higher when forming the base glass layer 4, the amount of volatilization of glass components other than silicon from the surface of the glass powder can be suppressed. Thus, it is assumed that changes in the composition of the glass powder are suppressed and the existence ratio of the crystals caused by changes in the composition is reduced. The temperature elevation rate when forming the base glass layer 4 is more suitably set to 200 degree/min or higher.

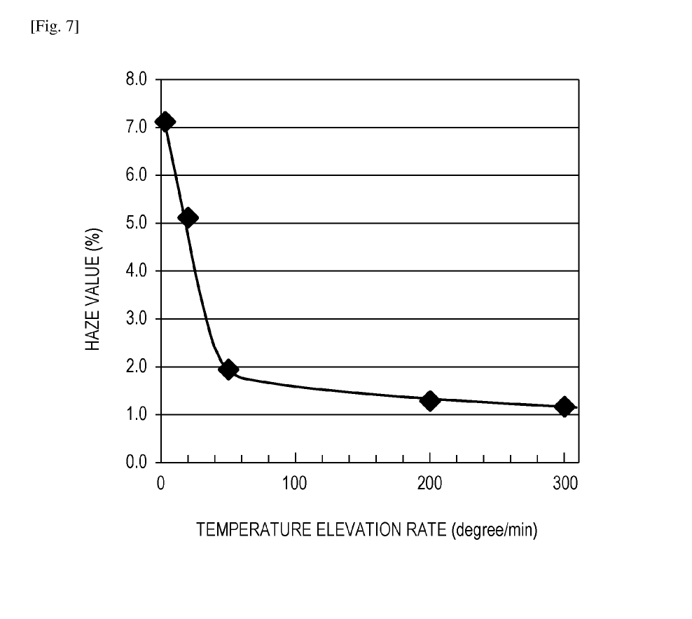

FIG. 7 shows the relationship between the temperature elevation rate when fusing glass powders and the haze value of the optical member. As shown in this figure, by setting the temperature elevation rate to 50 degree/min or higher, the haze value sharply becomes small as compared with temperature elevation rates lower than the temperature elevation rate above, so that a haze value of 2.0% or lower can be achieved. More specifically, it is important in the invention that the speed at which the glass powders are fused is high. The crystallization suppression effect described above is notably demonstrated when the temperature elevation rate is 50 degree/min or higher.

The temperature elevation rate of the invention is indicated by a temperature elevation rate in a temperature region equal to or higher than the crystallization temperature when increasing the temperature to a predetermined temperature for fusing the glass powders. More specifically, when the temperature elevation rate is fixed in the temperature region equal to or higher than crystallization temperature, the temperature elevation rate is set to the temperature elevation rate. When changing the temperature elevation rate in the temperature region equal to or higher than crystallization temperature, the average temperature elevation rate is set to the temperature elevation rate of the invention. When the heat treatment temperature intermittently changes from the temperature region equal to or lower than the crystallization temperature to the temperature region equal to or higher than the crystallization temperature, it is considered that the temperature elevation rate is high without limitation, and it is judged that the temperature elevation rate is included in the range of the invention. The upper limit of the temperature elevation rate is not generally determined.

Since the fusing temperature is set as appropriate according to the kind of glass, the invention is not limited at all by the fusing temperature. The fusing temperature suitably used in a usual phase separated glass is 600 degree or higher and 1200 degree or lower. In order to control cavities, the fusing temperature is set to a temperature equal to or higher than the crystallization temperature and equal to or lower than 1200 degree in the invention. When the fusing temperature is higher than 1200 degree, the composition of glass changes, so that the phase separation does not occur in some cases. The heating time for fusing the glass powders can be changed as appropriate according to the heating temperature and is suitably 5 minutes or more and 50 hours or lower.

The crystallization temperature of the glass powder in the invention is calculated as follows. The glass powder is heat treated at a temperature of 500 degree or higher and 1000 degree or lower at 10-degree intervals for 1 hour. The obtained sample was evaluated by an X ray diffraction structure analysis apparatus (XRD). The temperature at which the peak obtained from the crystal was confirmed was defined as the crystallization temperature. As a measuring apparatus, RINT2100 (Rigaku Corporation) can be used as the XRD, for example.

It is suitable for the base glass layer 4 to contain aluminum. An aluminum to silicon ratio A of the base glass layer 4 is suitably 0.005 or more and 0.090 or lower. With respect to the ratio A, a quantitative analysis of the constituent elements can be performed using an X ray photoelectron spectrum apparatus (XPS). When the amount of aluminum is in the range mentioned above, the crystallization is suppressed and the skeleton and the pore diameter of the structure tend to become small. Thus, the porous glass layer 2 with a lower scattering degree can be formed.

In the amount of aluminum in the range mentioned above, by further reducing cavities of the base glass layer 4 by reducing the fusing temperature itself, the porous glass layer 2 with a low scattering degree can be obtained.

As the heating method in the fusing, known heat treatment methods can be used. As an example of the heat treatment method, an electric furnace, an oven, an infrared radiation furnace, and the like are mentioned and arbitrary heating systems, such as a convection type, a radiation type, and an electric type, can be used.

Among the above, the infrared radiation furnace is particularly suitably used because the fusing of the glass powder is promoted.

When an atmosphere for firing is an oxygen rich atmosphere (oxygen concentration of 50% or more), a binder resin component can be effectively decomposed, so that cavities originating from the binder resin component in the film can be further reduced, and thus the atmosphere is more suitable.

The removal of the solvent component of the paste described above may be performed simultaneously with the fusing of the glass powder layer.

After forming the base glass layer 4, treatment for planarizing the surface of the base glass layer 4 may be performed. Specifically, it is desirable to polish the surface of the base glass layer 4. The planarization treatment may be performed after forming a phase-separated glass layer 5 described later. The planarization treatment of the surface may be performed only after the formation of the base glass layer 4, only after the formation of the phase-separated glass layer 5, or after each of the formation of the layer 4 and the formation of the layer 5.

### Process for Forming Phase-Separated Glass Layer

Subsequently, as illustrated in FIG. 6C, the base glass layer 4 is phase separated, and then the phase-separated glass layer 5 is formed on the base material 1.

The phase separation process for forming the phase-separated glass layer is more specifically performed by holding at a temperature of 450 degree or higher and 750 degree or lower for 3 hours or more and 100 hours or lower. The heating temperature in the phase separation process is not required to be a constant temperature. The temperature may be continuously changed or a plurality of different temperature stages may be provided.

By controlling the phase separation treatment time, the porosity of the porous glass layer 2 described later can be adjusted.

Since haze is required to be very low in the optical member, it is suitable that the structure, such as the skeleton and the pore, of the porous glass layer 2 become very fine in order to reduce the haze when used as an optical member.

Known heat treatment methods can be used as the heating method for the phase separation treatment. As an example of the heat treatment method, an electric furnace, an oven, infrared radiation, and the like are mentioned and arbitrary heating systems, such as a convection type, a radiation type, and an electric type, can be used.

### Process for Forming Porous Glass Layer

Finally, as illustrated in FIG. 6D, the phase-separated glass layer 5 is etched, and then the porous glass layer 2 is formed on the base material 1.

By etching treatment, a non-silicon-oxide-rich phase can be removed while leaving a silicon-oxide-rich phase of the glass layer which is phase separated and the portion where the silicon-oxide-rich phase remains becomes the skeleton of the porous glass layer 2 and the portion from which the non-silicon-oxide-rich phase is removed becomes a pore of the porous glass layer 2.

As the etching treatment for removing the non-silicon-oxide-rich phase, treatment is generally used which includes eluting the non-silicon-oxide-rich phase which is soluble by bringing the same into contact with an aqueous solution. As a method for bringing an aqueous solution into contact with glass, a method for immersing the glass in the aqueous solution is generally used. The method is not limited at all insofar as the glass and the aqueous solution are brought into contact with each other, e.g., applying the aqueous solution to the glass. As the aqueous solution required for the etching treatment, existing solutions which can elute non-silicon-oxide-rich phase, such as water, an acidic solution, and an alkaline solution, can be used. A plurality kinds of processes for bringing glass into contact with the solutions may be selected according to the intended use.

As the aqueous solution, the acidic solution is particularly suitable and, for example, inorganic acid, such as hydrochloric acid and nitric acid, is suitable. As the acidic solution, it is suitable to usually use an aqueous solution containing water as the solvent. The concentration of the acidic solution may be usually set as appropriate in the range of 0.1 mol/L or more and 2.0 mol/L or lower. In the acid treatment process using the acidic solution, the temperature of the acidic solution is set in the range of 15 degree or higher and 100 degree or lower and the treatment time is set to 1 hour or more and 500 hours or lower.

Depending on the glass composition and the production conditions, a silicon oxide layer of about several 10 nm which blocks etching is sometimes formed on the glass surface after phase separation heat treatment. The silicon oxide layer on the surface is also removable by polishing, acidic or alkaline treatment, or the like.

Among the above, polishing is particularly suitable because the flatness of the surface of the optical member can be secured and the haze (scattering) can be reduced.

After treating with an acidic solution, an alkaline solution, or the like, it is suitable to perform water treatment. By performing the water treatment, the adhesion of residual components to the porous glass layer 2 skeleton can be suppressed and the porous glass layer 2 with higher porosity is likely to be obtained and the scattering is likely to be suppressed.

The temperature in the water treatment process is generally suitably in the range of 15 degree or higher and 100 degree or lower. The water treatment process time can be determined as appropriate in accordance with the composition, size, and the like of the target glass and may be usually set to 1 hour or more and 50 hours or lower.

### EXAMPLES

Examples are described below but the invention is not limited by the Examples.

### Production Example of Glass Body

A mixed powder containing quartz powder, boron oxide, sodium oxide, and alumina was melted at 1500 degree for 24 hours using a platinum crucible in such a manner as to have a charge composition of 63% by weight SiO₂, 27% by weight B₂O₃, 7% by weight Na₂O, and 3% by weight Al₂O₃. Thereafter, the temperature of the glass was lowered to 1300 degree, and then poured into a graphite mold. The mold was allowed to cool in the air for about 20 minutes, held in a 500 degree slow cooling furnace for 5 hours, and then allowed to cool over 24 hours, thereby obtaining a glass body.

### Production Example of Glass Paste

The obtained glass body was crushed using a jet mill until the average particle diameter was 4.5 micrometer, thereby obtaining glass powders. The crystallization temperature Tc of the glass powder was 760 degree and the softening temperature Tm thereof was 620 degree.

Glass powder 60.0 parts by mass

alpha-terpineol 44.0 parts by mass
Ethyl cellulose (Registered trade mark: ETHOCEL Std 200 (manufactured by Dow Chemical Co.)) 2.0 parts by mass

The raw materials were stirred and mixed, thereby obtaining a glass paste.

### Example 1

In this example, a structure in which a porous glass layer is provided on a base material was produced as follows.

The glass paste was applied onto a 0.5 mm thick quartz base material (manufactured by IIYAMA PRECISION GLASS Co., Ltd.) cut into a size of 50 mm*50 mm by screen printing. As a printing machine, MT-320TV manufactured by MICRO-TEC Co., Ltd. was used. As a plate, a solid image of 30 mm*30 mm of #500 was used.

Subsequently, the resultant substance was allowed to stand still in a 100 degree drying furnace for 10 minutes to dry the solvent content, thereby forming a glass powder layer.

As a heat treatment process 1, the temperature was increased to 900 degree at a temperature elevation rate of 50 degree/min, and then the glass powder layer was heat-treated for 1 hour, and then, the temperature was lowered to normal temperature at a temperature lowering rate of 20 degree/min, thereby obtaining a base glass layer. When the glass layer was visually observed, the glass powder layer was sufficiently fused, and a transparent film was formed. In the glass powder, the aluminum to silicon ratio A is 0.054 and the ratio A includes in the range of 0.005 or more and 0.090 or lower. It is considered that the base glass layer also satisfies the range.

Thereafter, as a heat treatment process 2, the temperature was increased to 600 degree at a temperature elevation rate of 20 degree/min, and then the base glass layer was heat-treated for 50 hours. Then, the temperature was lowered to normal temperature at a temperature lowering rate of 50 degree/min, and then the top surface of the film was polished, thereby obtaining a phase separated glass layer.

The phase separated glass layer was immersed in an aqueous 1.0 mol/L nitric acid solution heated to 80 degree, and then allowed to stand still at 80 degree for 24 hours. Subsequently, the glass layer was immersed in distilled water heated to 80 degree, and then allowed to stand still for 24 hours. Then, a glass body was taken out from the solution, dried at room temperature for 12 hours, thereby obtaining an optical member 1. The thickness of the porous glass layer of the obtained optical member 1 was 4.2 micrometer. The cross section of the porous glass layer was observed at a magnification of 150,000 times at an accelerating voltage of 5.0 kV using a scanning electron microscope (FE-SEM S-4800, manufactured by Hitachi). As a result, a porous structure having three-dimensional through pores derived from the spinodal type phase separation was observed.

### Examples 2 and 3

Optical members 2 and 3 were obtained by performing the same process as that of Example 1, except changing the production conditions to production conditions shown in Table 1 as appropriate. The cross section of the porous glass layer was observed at a magnification of 150,000 times at an accelerating voltage of 5.0 kV using a scanning electron microscope (FE-SEM S-4800, manufactured by Hitachi). As a result, a porous structure having three-dimensional through pores derived from the spinodal type phase separation was observed in all the samples.

### Comparative Examples 1 and 2

In the comparative examples, optical members 4 and 5 were obtained by performing the same process as that of Example 1, except changing the production conditions to production conditions shown in Table 1 as appropriate. The cross section of the porous glass layer was observed at a magnification of 150,000 times at an accelerating voltage of 5.0 kV using a scanning electron microscope (FE-SEM S-4800, manufactured by Hitachi). As a result, a porous structure having three-dimensional through pores derived from the spinodal type phase separation was observed in all the samples.

The glass transition temperature (Tg) of glass powder shown in Table 1 is measured from the DTA curve measured by a differential type differential thermal balance (TG-DTA). As a measuring apparatus, Thermoplus TG8120 (Rigaku Corporation) can be used, for example. Specifically, the glass powder was heated at a temperature elevation rate of 10 degree/minute from room temperature using a platinum pan to thereby obtain the DTA curve. In the DTA curve, the endothermic initiation temperature at the endothermic peak was determined by extrapolation by a tangent method to be used as the glass transition temperature (Tg) of the glass powder.

The softening temperature Tm can be calculated by the following method. First, a target glass powder is applied onto a quartz glass in such a manner as to have a thickness of about 10 micrometer. Then, the coating film is heated for 1 hour in a temperature region of 500 degree to 1000 degree at 10-degree intervals, and then is observed under an electron microscope. The temperature at which the initiation of the fusing of the glass powder was observed in the observed image is defined as the softening temperature of the glass.

The crystallization temperature Tc of the glass powder is calculated as described above.

The thickness and the configuration of the porous glass layer of each optical member of Examples 1 to 3 and Comparative Examples 1 and 2 are summarized in Table 2.

TABLE 1

| | | | | | | Comp. | Comp. |
|---|---|---|---|---|---|---|---|
| | | | Ex. 1 | Ex. 2 | Ex. 3 | Ex. 1 | Ex. 2 |
| Glass | | Tg (degree) | 450 | 450 | 450 | 450 | 450 |
| | | Tm (degree) | 620 | 620 | 620 | 620 | 620 |
| | | Tc (degree) | 760 | 760 | 760 | 760 | 760 |
| Heat | Heat | Temperature | 900 | 900 | 900 | 900 | 900 |
| treat- | treatment | (degree) | | | | | |
| ment | process 1 | Time (hr) | 1 | 1 | 1 | 1 | 1 |
| condi- | | Temperature | 50 | 200 | 300 | 20 | 3 |
| tions | | elevation rate | | | | | |
| | | (degree/min) | | | | | |
| | Heat | Temperature | 600 | 600 | 600 | 600 | 600 |
| | treatment | (degree) | | | | | |
| | process 2 | Time (hr) | 50 | 50 | 50 | 50 | 50 |
| | | Temperature | 20 | 20 | 20 | 20 | 20 |
| | | elevation rate | | | | | |
| | | (degree/min) | | | | | |

TABLE 2

| | | | | | Comp. | Comp. |
|---|---|---|---|---|---|---|
| | | Ex. 1 | Ex. 2 | Ex. 3 | Ex. 1 | Ex. 2 |
| Porous | Existence ratio of | 1.03 | 0.32 | 0.29 | 3.77 | 4.87 |
| glass | crystals (%) | | | | | |
| layer | Porosity (%) | 43 | 50 | 48 | 42 | 41 |
| | Pore diameter (nm) | 42 | 43 | 43 | 38 | 39 |
| | Skeleton diameter | 41 | 39 | 40 | 42 | 41 |
| | (nm) | | | | | |
| | Film thickness | 4.2 | 5.1 | 4.5 | 5.0 | 3.8 |
| | (micrometer) | | | | | |

### Evaluation

Next, the following evaluation was performed for each optical member of Examples 1 to 3 and Comparative Examples 1 and 2. The results are summarized in Table 3.

### Evaluation of Haze Value

The haze value of each optical member of Examples 1 to 3 and Comparative Examples 1 and 2 was measured using a haze meter (NDH2000, manufactured by Nippon Denshoku, Inc.). The relationship between the haze and the temperature elevation rate is shown in FIG. 7.

### Evaluation of Surface Reflectance

The surface reflectance of each optical member of Examples 1 to 3 and Comparative Examples 1 and 2 was measured in a range of a wavelength region of 450 nm to 550 nm at 1-nm intervals using a lens reflectance meter (USPM-RUIII, manufactured by Olympus, Inc.).

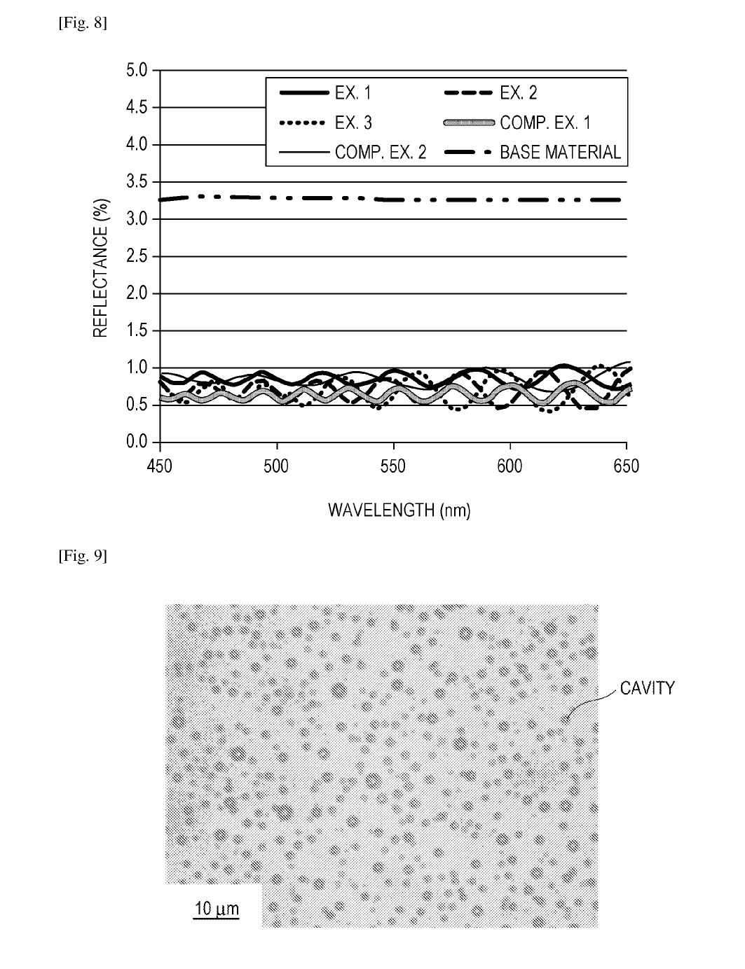

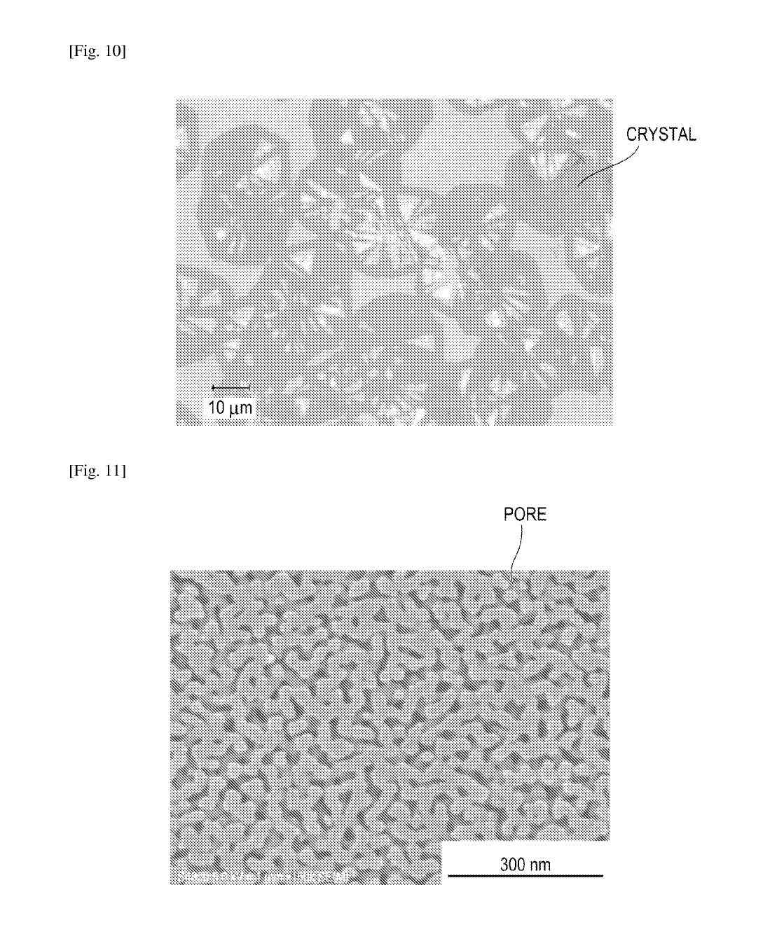

The results of the surface reflectance are shown in FIG. 8. The reflectance of the quartz glass used for the base material was about 3.3% over the range of the wavelength region of 450 nm to 650 nm. On the other hand, each optical member of Examples 1 to 3 and Comparative Examples 1 and 2 is 1.0 or lower in the wavelength region, which shows that the reflectance decreases.

TABLE 3

| | | | | | Comp. | Comp. |
|---|---|---|---|---|---|---|
| | | Ex. 1 | Ex. 2 | Ex. 1 | Ex. 2 | Ex. 3 |
| Manufac- | Temperature | 50 | 200 | 300 | 20 | 3 |
| turing | elevation rate | | | | | |
| method | (degree/min) | | | | | |
| Physical | Existence | 1.03 | 0.32 | 0.29 | 3.77 | 4.87 |
| properties of | ratio of | | | | | |
| porous layer | crystals (%) | | | | | |
| Optical | Haze value | 2.0 | 1.3 | 1.2 | 5.1 | 7.2 |
| properties | (%) | | | | | |

In each optical member of Examples 1 to 3, the maximum reflectance is about 1.0 and the haze value is 2.0 or lower.

When the optical members of Examples 1 to 3 were observed under an optical microscope, the existence ratio of crystals of 0.2 micrometer or more in the porous glass layer was 1.0% or lower in terms of two significant digits.

On the other hand, in each optical member of Comparative Examples 1 to 2, the existence ratio of crystals of 2.0 micrometer or more in the porous glass layer was larger than 1.0% and the haze value was higher than 2.0%.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-123567 filed May 30, 2012 and No. 2013-055539 filed Mar. 18, 2013, which are hereby in-corporated by reference herein in their entirety.

### REFERENCE SIGNS LIST

1 Base material
2 Porous glass layer
3 Glass powder layer
4 Base glass layer
5 Phase separated glass layer
314 Optical member

1. An optical member comprising:
a base material; and
a porous glass layer which is formed on the base material and has a three-dimensional through pore,
an existence ratio of crystals of 0.2 micrometer or more in the porous glass layer being 1.0% or lower.

2. The optical member according to claim 1, wherein the existence ratio of the crystals of 0.2 micrometer or more in the porous glass layer is 0.35% or lower.

3. The optical member according to claim 1, wherein a pore diameter of the porous glass layer is 5 nm or more and 50 nm or lower.

4. An image pickup apparatus comprising: the optical member according to claim 1; and an image pickup device which captures an image which transmits the optical member.

5. The image pickup apparatus according to claim 4, wherein, in the optical member, the base material and the porous glass layer are disposed in the stated order from the image pickup device side.

6. A method for manufacturing an optical member having a base material and a porous glass layer formed on the base material, the method comprising:
forming a glass powder layer containing a plurality of glass powders on the base material;
fusing the plurality of glass powders of the glass powder layer to form a base glass layer;
phase separating the base glass layer to form a phase-separated glass layer; and
etching the phase-separated glass layer to form a porous glass layer, the formation of the base glass layer including heating the glass powder layer at a temperature elevation rate of 50 degree(Celsius)/min or higher to a temperature equal to or higher than a crystallization temperature of the glass powder and equal to or lower than 1200 degree(Celsius).

7. The method for manufacturing an optical member according to claim 6, wherein the formation of the base glass layer includes heating the glass powder layer at a temperature elevation rate of 200 degree(Celsius)/min or higher to a temperature equal to or higher than the crystallization temperature of the glass powder and equal to or lower than 1200 degree(Celsius).

8. The method for manufacturing an optical member according to claim 6, wherein the formation of the base glass layer includes heating at a temperature of the glass powder equal to or higher than a crystallization temperature and equal to or lower than 1200 degree(Celsius) for a heating time of 5 minutes or more and 20 hours or lower.

9. The method for manufacturing an optical member according to claim 6, wherein the base glass layer contains silicon and aluminum.

10. The method for manufacturing an optical member according to claim 9, wherein an aluminum to silicon ratio in the base glass layer is 0.005 or more and 0.090 or lower.
